(19) United States
(12) Patent Application Publication
(10) Pub. No.: US 2026/0136349 A1
(43) Pub. Date: May 14, 2026

(54) METHODS AND APPARATUS RELATING TO BEAM MANAGEMENT

(71) Applicant: Samsung Electronics Co., Ltd., Gyeonggi-do (KR)

(72) Inventors: Oluwatayo Yetunde KOLAWOLE, Middlesex (GB); Chadi KHIRALLAH, Middlesex (GB); Mythri HUNUKUMBURE, Middlesex (GB)

(21) Appl. No.: 19/123,227

(22) PCT Filed: Nov. 2, 2023
(86) PCT No.: PCT/KR2023/017426

§ 371 Date: Apr. 22, 2025

(30) Foreign Application Priority Data
Nov. 4, 2022 (GB) 2216468.5
Sep. 28, 2023 (GB) 2314940.4

(51) Int. Cl. H04W 72/044; H04B 7/06; H04W 74/0833

(52) U.S. Cl. CPC H04W 72/046; H04B 7/06952; H04W 74/0833

(57) ABSTRACT

The disclosure relates to a 5G or 6G communication system for supporting a higher data transmission rate. A method for Artificial Intelligence/Machine Learning (AI/ML)-based beam management in a mobile communications system comprising a User Equipment (UE) and a network, the method comprising: prioritizing, based on an inference from a beam management AI/ML model, one or more beams among a plurality of beams for communication between the UE and the network; and performing communication between the UE and the network based on the prioritized one or more beams.

### TECHNICAL FIELD

Certain examples of the present disclosure relate to methods, apparatus and/or systems for performing one or more operations relating to beam management. Further, certain examples of the present disclosure relate to methods and apparatus for controlling beam management for one or more devices in an environment requiring high priority access, on the basis of Artificial Intelligence (AI)/Machine Learning (ML).

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHZ and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

### Solution to Problem

In accordance with a first aspect of the present disclosure, there is provided a method for Artificial Intelligence/Machine Learning (AI/ML)-based beam management in a mobile communications system comprising a User Equipment (UE) and a network, the method comprising: prioritizing, based on an inference from a beam management AI/ML model, one or more beams among a plurality of beams for communication between the UE and the network; and performing communication between the UE and the network based on the prioritized one or more beams.

In an example, prioritizing one or more beams includes at least one of: identifying, based on an inference from the beam management AI/ML model, one or more beams among the plurality of beams for beam sweeping for initial access to the network; identifying, based on an inference from the beam management AI/ML model, one or more beams among the plurality of beams for initial access to the network and allocating increased random access resources to the one or more beams; and identifying, based on an inference from the beam management AI/ML model, one or more beams among the plurality of beams for the UE to switch to and/or from.

In an example, the one or more beams are identified for one or more of a certain area, a certain time, a certain UE trajectory, or a certain UE identity.

In an example, the one or more beams are beams that have a high likelihood of being used by a high-priority UE in the certain location, a high-priority UE at the certain time, or a high-priority UE having the certain trajectory.

In an example, a high-priority UE is a UE having a certain latency requirement of the UE and/or a certain reliability requirement.

In an example, identifying one or more beams among the plurality of beams for beam sweeping for initial access to the network includes identifying one or more beams based on signals carried by the beams (e.g. PSS, SSS, PBCH).

In an example, performing communication between the UE and the network based on the prioritized one or more beams includes performing beam sweeping only on the identified one or more beams.

In an example, performing communication between the UE and the network based on the prioritized one or more beams includes controlling an order of beam sweeping based on the identified one or more beams.

In an example, performing communication between the UE and the network based on the prioritized one or more beams includes performing beam sweeping on the identified one or more beams before remaining beams of the plurality of beams (e.g. non-sequential beam sweeping).

In an example, performing communication between the UE and the network based on the prioritized one or more beams includes performing beam sweeping at an increased frequency on the identified one or more beams relative to remaining beams of the plurality of beams.

In an example, the identified one or more beams for beam sweeping for initial access to the network include a synchronisation signal block (SSB).

In an example, allocating increased random access resources to the one or more beams includes allocating an increased number of RACH codes to the one or more beams.

In an example, the allocation of random access resources is dynamic.

In an example, identifying one or more beams among the plurality of beams for the UE to switch to and/or from is performed when the UE is an RRC connected mode.

In an example, the identified one or more beams among the plurality of beams for the UE to switch to and/or from includes a beam expected to fail and/or a beam expected to become available.

In an example, performing communication between the UE and the network based on the prioritized one or more beams includes modifying a beam configuration of the UE and/or beam indexes based on the identified one or more beams among the plurality of beams for the UE to switch to and/or from.

In an example, the identity of the current beams used by the UE are input to the AI/ML model to identify the one or more beams.

In an example, the identity of only the current beams used by the UE that have a relatively higher performance are input to the AI/ML model to identify the one or more beams.

In an example, the prioritizing includes determining, based on the AI/ML beam management model, a time and/or area at which high-priority UE access is expected, and identifying beams associated with the determined time and/or area among the plurality of beams as the one or more beams.

In an example, the prioritized one of more beams are identified by (i.e. directly by) the inference from the AI/ML beam management model.

In an example, the method further comprises collecting network usage information of one or more UEs and training the AI/ML beam management model based on the collected network usage information.

In an example, the network usage information is network usage information of one or more UEs requiring high-priority access.

In an example, collecting the network usage information is performed by one or more of a UE, a network entity, and an external entity.

In an example, the training of AI/ML beam management model is performed by one or more of a UE, a network entity, and an external entity.

In an example, the network usage information includes beam usage information.

In an example, the beam usage information includes information on one or more of: a beam used by a UE to communicate with the network, a beam used by a UE for initial access with the network, a location of a UE using a beam to communicate with the network, a frequency of use of a beam used by a UE to communicate with the network, a trajectory of a UE using a beam to communicate with the network, a time at which a beam is used by a UE to communicate with the network, a beam switched to or from by a UE to communicate with the network, an identity of a UE using a beam to communicate with the network, an access priority of a UE using a beam to communicate with the network, a latency requirement of a UE using a beam to communicate with the network, a reliability requirement of a UE using a beam to communicate with the network, SSB/CSI-RS measurement data associated with a beam, and a beam that has failed whist being used by a UE to communicate with the network.

In an example, the beam usage information is collected for a subset of the plurality of beams and/or a subset of collected beam usage information is used to train the AI/ML beam management model.

In an example, the subset of the collected beam usage information includes information on one or more of and/or the subset of the plurality of beams includes one or more of: a beam used by a high-priority UE, a beam used by a UE in a location associated with high-priority access, a beam used by a UE at a high-priority time, a beam with a relatively higher performance, and a beam that has failed.

In an example, the subset of the collected beam usage information includes information on and/or the subset of the plurality of beams are associated with: a certain single UE or a certain plurality UEs.

In an example, the AI/ML beam management model is UE specific or non-UE specific.

In an example, the method is performed by a UE and/or a network entity.

In an example, the network entity includes a base station (e.g. gNB).

In an example, the prioritized one or more beams include one or more of transmission (Tx) beams, reception (Rx) beams, and beam pairs (Rx and Tx).

In an example, the prioritized one or more beams are included in/form/define a set of beams (e.g. Set B of beams).

In an example, performing communication between the UE and the network based on the prioritized one or more beams includes reporting reception characteristics of only the identified one or more beams among the plurality of beams.

In an example, the method further comprises receiving, at the UE from the network, an indication of the prioritized one or more beams.

In an example, the prioritized one or more beams is a subset of the plurality of beams.

In an example, the prioritizing is performed by the UE or the network.

Other aspects, advantages, and salient features of the invention will become apparent to those skilled in the art from the following detailed description taken in conjunction with the accompanying drawings.

### Advantageous Effects of Invention

Accordingly, through such a method, a technical effect of avoiding a beam failure may be provided, thereby enhancing efficiency.

### BRIEF DESCRIPTION OF DRAWINGS

Embodiments/examples of the present disclosure are further described hereinafter with reference to the accompanying drawings, in which:

FIG. 1 shows a representation of a modified beam sweeping procedure according to an example of the present disclosure.

FIG. 2 shows a representation of modifying a beam sequence according to an example of the present disclosure.

FIG. 3 shows a representation of a method according to an example of the present disclosure.

FIG. 4 is a block diagram illustrating an example structure of a network entity in accordance with certain examples of the present disclosure.

### MODE FOR THE INVENTION

The content of the following documents is referred to below and/or their content provides background information that the following disclosure should be considered in the context of:
GPP TS 22.261-Service requirements for the 5G system, SA1, Release 18 (e.g., V18.7.0);

Wireless or mobile (cellular) communications networks in which a mobile terminal (e.g., user equipment (UE), such as a mobile handset) communicates via a radio link with a network of base stations, or other wireless access points or nodes, have undergone rapid development through a number of generations. The 3rd Generation Partnership Project (3GPP) design, specify and standardise technologies for mobile wireless communication networks. Fourth Generation (4G) and Fifth Generation (5G) systems are now widely deployed.

3GPP standards for 4G systems include an Evolved Packet Core (EPC) and an Enhanced-UTRAN (E-UTRAN: an Enhanced Universal Terrestrial Radio Access Network). The E-UTRAN uses Long Term Evolution (LTE) radio technology. LTE is commonly used to refer to the whole system including both the EPC and the E-UTRAN, and LTE is used in this sense in the remainder of this document. LTE should also be taken to include LTE enhancements such as LTE Advanced and LTE Pro, which offer enhanced data rates compared to LTE.

In 5G systems a new air interface has been developed, which may be referred to as 5G New Radio (5G NR) or simply NR. NR is designed to support the wide variety of services and use case scenarios envisaged for 5G networks, though builds upon established LTE technologies.

In the context of 5G, one class of use case is ultra-reliable and low-latency communication (URLLC). The type of services for which URLLC may be relevant are those seen to require very low latency and very high reliability, covering both human- and machine-centric communication. Some non-limiting examples of such services are traffic safety (e.g., vehicle-to-vehicle communication involving safety), automatic control, and factory automation (e.g., wireless control of industrial equipment). URLLC may be used in support of industrial internet of things (IIoT) use cases. The IIoT, in one scenario, may refer to interconnected sensors, devices and/or instruments which are networked together with computer's industrial applications. Examples of IIoT use cases are factory automation, electrical power distribution and transport industry.

In controlled or private radio environments with a high density of different user equipments (UEs)/devices (e.g., in a IIoT use case), some of these devices may need high priority access (lower latency and higher reliability) in some of the temporal and/or spatial zones. However, this will not be needed all the time or in all locations; that is, it may not be necessary to categorize these devices as requiring URLLC and/or to assign them special access rights, e.g., grant free access.

The following description of examples of the present disclosure, with reference to the accompanying drawings, is provided to assist in a comprehensive understanding of certain examples of the present invention. The description includes various specific details to assist in that understanding but these are to be regarded as merely exemplary. Accordingly, those of ordinary skill in the art will recognize that various changes and modifications of the examples described herein can be made without departing from the scope of the invention or disclosure.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present disclosure.

The terms and words used herein are not limited to the bibliographical or standard meanings, but are merely used to enable a clear and consistent understanding of the invention.

Throughout the description of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description of this specification, the singular form, for example “a”, “an” and “the”, encompasses the plural unless the context otherwise requires. For example, reference to “an object” includes reference to one or more of such objects.

Throughout the description, the expression “at least one of A, B and/or C” (or the like) and the expression “one or more of A, B and/or C” (or the like) should be seen to separately include all possible combinations, for example: A, B, C, A and B, A and C, A and B and C.

Throughout the description of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment or example are to be understood to be applicable to any other aspect, embodiment or example described herein unless incompatible therewith.

Certain examples of the present disclosure provide methods, apparatus and/or systems for at least one of: training AI/ML model(s) using data relating to devices in an environment requiring high priority access (e.g., URLLC); prioritizing beam indexes within a SSB for beams which have a high likelihood of usage by high priority device(s) in a given time and/or given location (e.g., on the basis of a trained AI/ML model); allocating more RACH resources (e.g., codes), proportionally, for the prioritised beams (e.g., on the basis of a trained AI/ML model), such that high priority devices may perform/complete random access procedure with less delay; and modify beam indexes or a beam configuration pattern for a device in RRC connected mode after identifying/predicting spots with beam failure (e.g., on the basis of a trained AI/ML model). Note, however, that the present disclosure is not limited to these examples, and includes other examples.

The following examples are applicable to, and use terminology associated with, 3GPP 5G. However, the skilled person will appreciate that the techniques disclosed herein are not limited to these examples or to 3GPP 5G, and may be applied in any suitable system or standard, for example one or more existing and/or future generation wireless communication systems or standards. The skilled person will appreciate that the techniques disclosed herein may be applied in any existing or future releases of 3GPP 5G NR or any other relevant standard. For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network.

A particular network entity may be implemented as a network element on a dedicated hardware, as a software instance running on a dedicated hardware, and/or as a virtualised function instantiated on an appropriate platform, e.g. on a cloud infrastructure.

The skilled person will appreciate that the present invention is not limited to the specific examples disclosed herein. For example:
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements, entities and/or messages may be added to the examples disclosed herein.
One or more non-essential elements, entities and/or messages may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed may be modified, if possible, in alternative examples.
The transmission of information between network entities is not limited to the specific form, type and/or order of messages described in relation to the examples disclosed herein.

Certain examples of the present disclosure may be provided in the form of an apparatus/device/network entity configured to perform one or more defined network functions and/or a method therefor. Such an apparatus/device/network entity may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). Certain examples of the present disclosure may be provided in the form of a system (e.g., a network) comprising one or more such apparatuses/devices/network entities, and/or a method therefor.

It will be appreciated that examples of the present disclosure may be realized in the form of hardware, software or a combination of hardware and software. Certain examples of the present disclosure may provide a computer program comprising instructions or code which, when executed, implement a method, system and/or apparatus in accordance with any aspect, example and/or embodiment disclosed herein. Certain embodiments of the present disclosure provide a machine-readable storage storing such a program.

As mentioned above, new frameworks and architectures are being developed as part of 5G networks in order to increase the range of functionality and use cases available through 5G networks. One such new framework is the use of artificial intelligence/machine learning (AI/ML), which may be used for the optimisation of the operation of 5G networks.

In AI/ML operation, AI/ML models and/or data might be transferred across the AI/ML applications (e.g., application functions (AFs)), 5GC (5G core), UEs (user equipments) etc.). Without limitation, the AI/ML works could be divided into two main phases: model training and inference. During model training and inference, multiple rounds of interaction may be required.

In Section 6.40 (‘AI/ML model transfer in 5GS’) in TS 22.261 [1], three types of AI/ML operations to be supported in Release 18 are described as follows:

### a) AI/ML Operation Splitting Between AI/ML Endpoints

The AI/ML operation/model is split into multiple parts according to the current task and environment. The intention is to offload the computation-intensive, energy-intensive parts to network endpoints, whereas leave the privacy-sensitive and delay-sensitive parts at the end device. The device executes the operation/model up to a specific part/layer and then sends the intermediate data to the network endpoint. The network endpoint executes the remaining parts/layers and feeds the inference results back to the device.

### b) AI/ML Model/Data Distribution and Sharing Over 5G System

Multi-functional mobile terminals might need to switch the AI/ML model in response to task and environment variations. The condition of adaptive model selection is that the models to be selected are available for the mobile device. However, given the fact that the AI/ML models are becoming increasingly diverse, and with the limited storage resource in a UE, it can be determined to not pre-load all candidate AI/ML models on-board. Online model distribution (i.e. new model downloading) is needed, in which an AI/ML model can be distributed from a NW (network) endpoint to the devices when they need it to adapt to the changed AI/ML tasks and environments. For this purpose, the model performance at the UE needs to be monitored constantly.

### c) Distributed/Federated Learning Over 5G System

The cloud server trains a global model by aggregating local models partially-trained by each end devices. Within each training iteration, a UE performs the training based on the model downloaded from the AI server using the local training data. Then the UE reports the interim training results to the cloud server via 5G UL channels. The server aggregates the interim training results from the UEs and updates the global model. The updated global model is then distributed back to the UEs and the UEs can perform the training for the next iteration.

Certain embodiments of the present disclosure use AI/ML in beam management by a network entity (including a network function, a network node etc.), such as a UE, or the network (NW). In particular, certain embodiments use AI/ML data trained with data from a type of environment (e.g., a controlled radio environment, a private radio environment etc.) to predict/identify/determine when/where a UE (or other network entity) in the environment will require high priority access (that is, a UE requiring low latency (e.g., relatively low latency) and/or high reliability (e.g., relatively high reliability)). In certain embodiments, the NW or a network entity may use AI/ML (e.g., one or more AI/ML models or AI/ML inference) to pre-configure beam pattern(s) for use in communication with a network entity, and improve legacy beam management procedures.

As an example of the above, a UE or the NW may determine a beam management solution (or procedure) based on AI/ML data, such as a AI/ML model which has been trained on data obtained from the environment (e.g., data relating to a time and/or location of a UE (or other device) at the time and/or location that the UE required high priority access). Through using the AI/ML model, the NW or UE may perform a beam management procedure on the basis of AI/ML inference; for example, this may allow for a prioritised beam pair to be used for communication by the UE in the environment at a time when the UE will require high priority access and/or at a location where the UE will require high priority access.

When discussing beam management solutions, improvements in accuracy of beam prediction, reductions in overhead and complexity from beam sweeping, and latency reduction are desirable for various scenarios and configurations. Certain embodiments of the present disclosure aim to provide one or more of these effects and/or to mitigate, reduce or manage associated problems (e.g., a problem of reducing overhead, complexity, latency etc.). The existing downlink beam management framework for NR relies on beam operations including beam sweeping, beam measurement and reporting, beam indication, and beam failure detection and recovery. By default, beam sweeping is based on sequentially scanning of beams to find transmitter-receiver beam pairs suitable for data and control channels. However, this may lead to a high overhead in certain scenarios e.g., controlled IIoT settings.

At 3GPP TSG RANI meeting RANI #110-bis-e (October 2022), options for further study on beam prediction to improve beam management were agreed as follows:
Study the following options on the selection of Set B of beams (pairs)
   Option 1: Set B is fixed across training and inference
   Option 2: Set B is variable (e.g., different beams (pairs) patterns in each time instance/report/measurement during training and/or inference), FFS:
      Opt A: Set B is changed following a set of pre-configured patterns
      Opt B: Set B is randomly changed among pre-configured patterns
      Opt C: Set B is randomly changed among Set A beams (pairs)
      The number of beams (pairs) in Set B can be fixed or variable
      Note: BM-Case1 and BM-Case2 may be considered for different option.
   Other options are not precluded.

3GPP TSG RANI has made a number of agreements relating to beam management, at meetings RANI #109-c (May 2022) and RANI #110 (August 2022) (see Annex). The agreements relate to the sub use cases BM-Case1 and BM-Case2, with the agreements being on the input/output of AI/ML modes. A number of issues relating to beam management are unresolved.

Certain embodiments of the present disclosure aim to provide intelligent and robust beam management through alterations in the beam configurations through the knowledge gained through AI/ML for high priority access for devices, or network entities, in a radio environment (e.g., a multi-beam radio environment). This may speed up beam management operations and reduce beam failure incidents, ensuring high/higher reliability. In particular, certain embodiments address the implementation of option B (above) where the set of beams (i.e., beam pairs) is randomly changed among pre-configured patterns.

Further, certain examples of the present disclosure include one or more of the following operations, relating to the improvement of beam management for one or more high priority UEs (or other network entities), based on information associated with AI/ML (e.g., information relating to the use of AI/ML such as AI/ML inference, data obtained through an AI/ML operation etc.):
(1) prioritizing beam indexes within the synchronization signal block(s) (SSB(s)) for one or more beams which have high likelihood of usage by high priority UE's in a certain timeslot (e.g., a time, a period, a duration etc.) and/or area (e.g., a location, a coordinate, a region etc.);
(2) allocating more random access channel (RACH) codes for these prioritized beams (for example, proportionally, in relation to other, un-prioritised beams), so that the high priority UEs could perform/complete random access procedure without delays.
(3) modifying beam indexes and/or beam pattern configuration for UE in RRC (radio resource control) connected mode after identifying (or predicting, or determining) a time, a location or a state associated with beam failure.

In certain examples, to facilitate the performing of one or more of the methods described herein, it will be appreciated that AI/ML model training may be performed.

For instance, in a controlled or private radio environment, such as may be found in a IIoT network (such as in a factory or office), patterns of network usage by one or more devices (e.g., UEs or other network entities) in the environment may be recorded over time. Usage data (such as data relating to time periods, time slots, locations, device states etc. when a device requires high priority access) collected in this manner may be used to train one or more AI/ML models, where the AI/ML models may be used in estimating/identifying times and/or zones (e.g., locations) when a device or devices in the environment will require high priority access.

It will be appreciated that the obtaining of the data (such as the patterns or other recorded information relating to high priority access) may be obtained by an entity within the environment or by an external entity such as a connected network or network entity. For example, devices in the environment may record data about network usage (such as time and/or location data relating to high priority usage) and provide this data to another entity in the environment which collates the data from the devices and uses the data for AI/ML model training or transfers the data to another network entity for AI/ML model training. In another example, one or more entities in the environment gather data about network usage of devices in the environment, where this data is then gathered at an entity for AI/ML training. In other words, it will be appreciated that the data may be obtained by the devices themselves or may be obtained by another network entity capable of monitoring usage by the devices, and the data may then be provided to, or collected at, one or more network entities for use in AI/ML model training.

The data or measurement collection for the AI/ML model training should preferably be efficient and/or require relatively low overheads. For the prioritized beam sweeping discussed above, there may be a relatively high overhead in terms of reference signals in beam sweeping (e.g.: SSB and/or CSI-RS) if measurements are collected from all the available beam pairs (Tx and Rx). To reduce such overheads data may be collected only from a sub-set of the all available beam pairs, i.e. beam pairs that are actually selected by the gNB and UE for establishing a RRC-connection. In example, measurement collection is done in environments where this subset (N beam pairs out of a total of possible M beam pairs) is utilized with a high probability. Thus the measurement data collected (as SSB indexes or CSI-RS values) will have a higher relevance to the actual beam selection scenarios associated with high priority access. The ratio (N/M) can be an effective indicator for overhead reduction, which can be quantified as:

$$Overhead Recution = 1 - \frac{N}{M} .$$

Once an AI/ML model (or, if desired, one or more AI/ML models) are trained for use in beam management (such as one or more of the operations described above), an AI/ML model may be provided to a UE (or other device in the environment) and to a network entity communicating with the UE (which may be the network entity which trained the AI/ML model, or may be another network entity such as a base station (e.g., gNB) or other part of the network. That is, an AI/ML model is provided to an entity (such as a device) in the environment which will be using the AI/ML model to perform, or identify/determine, an operation related to beam management, for example one of operations (1), (2), (3) above. It will be appreciated that a different AI/ML model may be provided to different entities: for example, a device may be provided with an AI/ML model specific to that device, while a management entity in the environment (or NW) may be provided with an AI/ML model which will allow for predictions relevant both to the device and to other devices in the environment.

In an example of the present disclosure, a method for modifying a beam sweeping procedure is provided. The beam sweeping procedure may be for an initial access.

Regarding an initial access, where a device (e.g., a UE) is making initial access to the network (e.g., of a controlled environment), in one operation, the UE may control a beam sweeping operation (e.g., change the order of beam sweeping) based on information relating to AI/ML. For example, based on AI/ML inference, the UE may change an order of beam sweeping with an aim of increasing the frequency (of appearance) of SSB beams (i.e., carrying the primary synchronization signal (PSS), the secondary synchronization signal (SSS) and the physical broadcast channel (PBCH)) which have a high likelihood of usage by a high priority device in a given/predetermined time and/or location (these may be referred to as prioritized beams, which may be regarded as beams most used by devices with high priority access). The device may use information from AI/ML inference to predict a high-priority access state (e.g., that the device may be in a zone/location where high-priority access is predicted to be required, or that an upcoming time period is one in which the device is predicted to require high priority access). In other words, using the AI/ML model, the network may infer that a device will require, or requires, high priority access and so will perform a beam sweeping procedure accordingly; changing the order of the beam sweeping (e.g., from a first order to a second order) so as to better identify beam pairs suited for high priority access.

Also relating to initial access, separately to or in combination with the above, in another operation, the network (e.g., a UE in the environment) may control a RACH operation (e.g., allocate RACH resources (e.g., RACH codes)) based on information relating to AI/ML. For example, the network may allocate more RACH resources to one or more, or all, of the prioritized beams based on an AI/ML model, such as by using information (e.g., results) from AI/ML inference. In further examples, the RACH operation may be controlled dynamically according to a time and/or a location, based on the information relating to AI/ML. For instance, the network may dynamically allocate RACH resources according to a time period (e.g., a current time or an upcoming/future time period etc.) and/or according to a location (e.g., a geographic region, a zone, an orientation etc.) on the basis of AI/ML inference.

The AI/ML data collection for this PRACH code allocation optimisation can be based on any of the measurement collection approaches for beam sweeping detailed above. In addition to identifying the subset of beam pairs N, which is used in the AI/ML model training, the frequency of usage for each of the N beam pairs can also be recorded. Training the AI/ML model using such a subset of beam pairs and the frequency of usage, and using the trained model for RACH code optimisation may reduce the overheads.

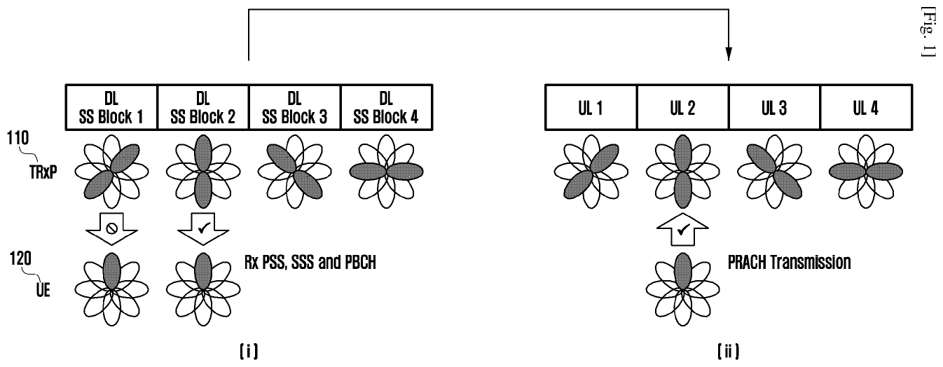

Together, and separately, these operations relating to initial access may provide a technical effect of speeding-up the reading (or identification) of beam information in the downlink and/or speeding-up the initial access through RACH in the uplink. FIG. 1 (i) illustrates a method according to the above operation(s) to speed up UE 120 access in the downlink (DL), and FIG. 1 (ii) illustrates a method according to the above operation(s) to speed up UE 120 access in the uplink (UL). It will be appreciated that FIG. 1 (i) and FIG. 1 (ii) together show mapping between DL SS Blocks and corresponding UL resources for PRACH.

FIG. 1 (i) illustrates the UE 120 (although it will be appreciated that this may be any device in the environment) receiving, from a transmitting entity 110 (e.g., on the network side, such as a gNB), PSS, SSS and PBCH, as may be included in a DL SSB. The UE 120 has modified beam sweeping based on AI/ML inference, for example, and so speedily identifies a beam pair for DL and for UL. It may be considered that the beam pattern from TRxP 110 (e.g., a gNB) sweeps in time and the UE 120 identifies the time instance where it gets the best signal; as such, the beam index is indicated by time slot. According to an example of the present disclosure, an orderly sequence of 1, 2, . . . , n is changed/modified based on an AI/ML model.

In another example of the present disclosure, which may optionally be combined with either or both of the aforementioned operations relating to initial access, a method for modifying a beam management procedure is provided. The method may relate to a stage other than initial access, for example when a device (such as a UE in the environment) is in RRC connected mode.

For example, when the device is in RRC connected mode, the network may control a beam management operation based on information relating to AI/ML. In one example, the beam management operation may be a beam switching, such that the network and device may predict, or determine, a beam pair switching sequence based on information trained for the device's movements (e.g., in the environment), where beam switching is then performed (e.g., guided) based on the prediction.

Similar to the approaches detailed above for the efficient collection of measurements for beam sweeping optimisation, measurement (data) collection for beam switching optimisation through an AI/ML model should preferably also be done efficiently. The collected measurements can be CSI-RS or DMRS indications about beam selection. The measurements should preferably but not necessarily exclusively be collected for beams with high reported values (by UEs) for these reference signals. Thus in practice AI/ML measurements should be done in environments where UEs move across multiple beams (or multiple gNBs/eNBs).

An example according to the method for modifying a beam management procedure, such as described above, may predict, in advance, a trajectory of a device, may identify expected beam failure locations and/or times (e.g., time periods, time slots etc.), and/or may allow for the provision of alternative beam set configuration(s) in advance, to allow the device to avoid such a beam failure(s). For example, referring to the latter, the alternative beam set configuration(s) may be provided from the network side in a previous communication/signalling, such that the device may switch to an alternate beam set upon detecting/predicting an expected beam failure (i.e., of a current beam configuration).

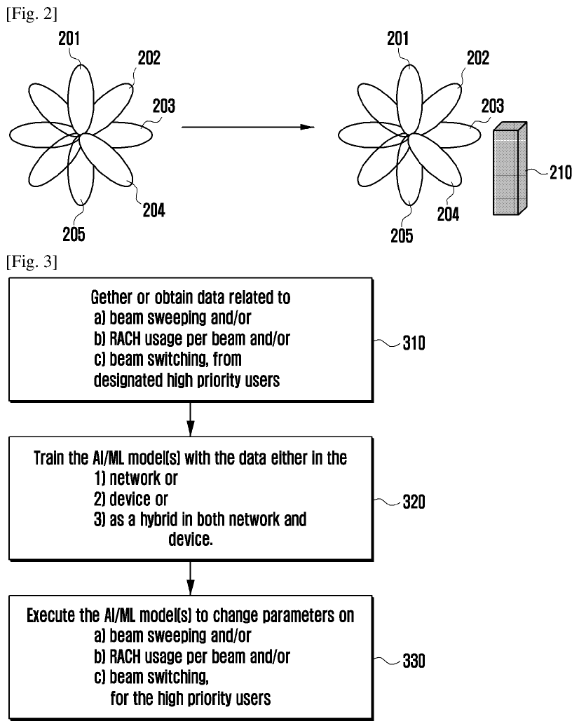

FIG. 2 illustrates a method of modifying a beam management procedure (specifically, modifying a beam sequence), for example in accordance with one of those described above. In FIG. 2: beam 201, beam 202, beam 203, beam 204 and beam 205 are initially configured for a device, as shown on the left side of the figure. Based on a trajectory of the device and/or on detecting an expected failure location for beam 203 and beam 204, the beam configuration is modified such that beam 203 and beam 204 are deselected due to blockage 210. Knowledge of the trajectory (or predicted trajectory) and/or expected failure location is gained through use of a suitably trained AI/ML model such as described above, the AI/ML model being trained with suitable data from the environment, with AI/ML inference applied thereafter. Accordingly, through such a method, a technical effect of avoiding a beam failure may be provided, thereby enhancing efficiency.

In certain examples, the network (or network-side) configures a beam set for a device (e.g., a UE), for use in a given location and/or at given time period, based on assistance information (e.g. information derived from AI/ML inference) on the device's environment (e.g. highly used beams, blockage, other) and/or UE trajectory in a given time and/or location and/or AI/ML inference.

In certain examples, if configured by the network-side, the device may select or switch to a beam in the configured beam set, according to its presence in a given time and/or location. In other words, if the device detects that the given time (e.g., a specified time period, or identified time frame etc.) is reached or occurs, and/or that it is in the given location (e.g., within a specific geographic zone, or in a relative position, etc.), then the device may switch to a beam in the beam set configured by the network.

If a method in accordance with one of the above disclosed examples of the present disclosure is to be applied to all active devices (e.g., active UEs) in a radio environment (e.g., an IIoT environment), to avoid conflict in beam and RACH resource (e.g., code) prioritization and/or in beam sequencing for mobility, then an exemplary method in accordance with the present disclosure includes an operation of identifying devices, and their locations and/or the time zones in which the devices need high priority access, and an operation of tagging this corresponding data (i.e., the identified information on the devices, time zones, locations etc.) as indicating high priority. By tagging the data in such a manner, suitable data may be used for the training of one or more AI/ML models. In other words, AI/ML model training is facilitated through identifying locations and/or time periods when a device needs high priority access, and tagging the identified locations and/or time periods to an identification of the device (e.g., a unique device identifier), such that an AI/ML model may be trained through use of knowledge of when and/or where that device has, in the past, required high priority access.

According to certain examples of the present disclosure, a method in accordance with one of the above described examples may make use of a capability in beam management to alter the beam sequencing in SSB and alter the number of RACH codes per beam. For instance, one operation described above involves changing the order of beam sweeping based on AI/ML to increase a frequency of appearance of SSB beams more likely used by high priority devices in a given time/location, and another operation described above involves allocating more RACH resources to such prioritized beams dynamically in time and/or location, based on AI/ML (e.g., assistance information, AI/ML inference). For such a case/cases, there may need to be additional signaling to capture the different number of RACH codes per beam, for a given RACH occurrence. To address this, certain examples use differential coding to indicate the ± change in the number of RACH codes from the default setting can be useful to reduce signaling. This can be in +2n additional codes for example, when n can be signalled as {1, 2, 3, . . . }.

According to certain examples of the present disclosure, a method in accordance with one of the above examples may make use of AI/ML models to provide an input (e.g., one or more parameters) into a beam selection procedure in RRC connection mode motion for a high priority device or high priority devices. For instance, one operation described above involves predicting a beam switching sequence based on AI/ML (e.g., assistance information, AI/ML model, AI/ML inference etc.) trained based on the movements of the device(s), where switching beam configuration may allow the device(s) to avoid beam failure due to a blockage or the like. For such a case/cases, there may need to be additional signalling to capture the beam related information for use as AI/ML training data in the RRC connected mode for the device. In certain examples, to reduce a resulting signalling overhead, differential coding is used for the beam sequence from the start point of the RRC connected mode for the device. In an example, this is applied to the network side (e.g., to a gNB side), where many beams (e.g., 64 beams, 128 beams) can be employed by the massive MIMO systems. With this differential coding, the shift from the start beam position may be signalled as ±1, ±2 or ±3, for example. In another example, from the device side, different device models will support a different number of beams (e.g., 4 beams, 8 beams, 16 beams). In this case, reporting this information to the AI/ML model (or entity training the AI/ML model) may be needed to avoid ambiguity.

In certain examples, another option for reducing the signalling (i.e., signalling overhead) for high priority mobile devices in RRC connected mode is to combine only the subset of device (e.g., UE) reported best beams with the device orientation/trajectory information as one or more inputs for the AI/ML model to make the inference of beam failure locations and/or time. In controlled environments, some of the high priority devices will need to be tracked all the time-so there will be device trajectory information available and the ‘expected’ best beams. The AI/ML model can be fed with exceptions to this (e.g., blockages or beam failure locations), so the model can be trained for anomaly detection.

That is, at the network entity generating or training the AI/ML model, as inputs for the AI/ML model, the network entity combines a subset of UE reported best beams (as opposed to all UE reported best beams) with corresponding UE orientation/trajectory/location information, thereby reducing signalling overhead compared to a case where information from all UEs is used/combined as an input(s) to the AI/ML model. It will be appreciated that the selection/identification of the subset may be achieved in any number of ways; for example, the network entity may use information from specific UEs (such as may have been designated or selected at random), information indicating known high priority UEs, information indicating a UE requiring high priority access etc.

FIG. 3 illustrates a method(s) in accordance with examples of the present disclosure. It will be appreciated that, in non-limiting examples, a method according to FIG. 3 may be performed by a network entity.

In operation 310, data is obtained or gathered (e.g., requested, received, identified, inferred etc.) which is to be used for AI/ML model training. For example, a network entity may gather or obtain data related to a) beam sweeping and/or b) RACH usage per beam and/or c) beam switching, from designated high priority users. The data may be suitable for the training of the AI/ML model. Accordingly, for a AI/ML model to be used in a method according to one of the examples discloses herein (for instance, relating to identifying a time and/or location when a device may need high priority access, and/or to identifying a prioritised beam for such a device needing high priority access), the data may relate to time data, access requirements, location data (e.g., high priority access required), device data (e.g., identifier) for one or more devices in the environment. As mentioned above, in certain examples the data may further relate to beam sweeping, RACH usage per beam and/or beam switching. In general, the data may relate to beam management. This data may be collected from device(s) in the environment, for example.

For example, a network entity may obtain time data indicating times, time periods, time zones etc. when a device requires/needs high priority access and/or experiences a failure (that is, a deterioration in access), and (optionally) may combine this information with an identifies of the device. In another example, the network entity may obtain location (or orientation, or trajectory) data indicating locations, positions, trajectories, orientations etc. when a device requires/needs high priority access and/or experiences a failure (that is, a deterioration in access), and (optionally) may combine this information with an identifies of the device. Such time data and/or location data may then be used in training an AI/ML model (as discussed below); if the time data and/or location data is combined with an identifier for the corresponding device, this may personalise a part of the AI/ML model to that device. In addition, as described above, in certain examples, locations and/or the time zones in which the devices need high priority access, and an operation of tagging this corresponding data (i.e., the identified information on the devices, time zones, locations etc.) as indicating high priority.

In operation 320, AI/ML model(s) are trained with the data either in the 1) network or 2) device or 3) as a hybrid in both network and device. For example, a network entity or device trains an AI/ML model using the obtained data. It will be appreciated that the network entity may instead send the data to another network entity for the training of the AI/ML model, and so such a case may be considered to be included in FIG. 3 also (i.e., operation 310 being split between two network entities, in which case operations 320 and 330 would be performed by a network entity having possession of the AI/ML model). In certain examples, the AI/ML model(s) training may be performed centrally (e.g., in the network, or by/at a single entity in the network), distributed (e.g., in one or more devices in the environment or network), or hybrid (e.g., a combination of by the network and by one or more devices).

The person skilled in the art would understand how an AI/ML model may be trained using data such as described above. In some examples, if the data is tagged as described above, an AI/ML model may be trained through use of knowledge of when and/or where that device has, in the past, required high priority access.

In certain examples, referring to the corresponding option for reducing signalling as described above, only a subset of devices reported best beams with the device orientation/trajectory information as one or more inputs for the AI/ML model. Here, in one option, only data from the corresponding devices may be gathered/obtained.

In certain examples, it will be appreciated that operations 310 and/or 320 are ongoing, with more data being gathered/obtained and/or the AI/ML model being further trained (e.g., refined) over time. It is therefore possible for operations 310 and/or 320 to be persistently performed even though operation 330 is also performed.

In operation 330, the network entity having the trained AI/ML model may use the AI/ML model in beam management for one or more devices in the environment. For example, the AI/ML model(s) may be executed to change one or more parameters in relation to a) beam sweeping and/or b) RACH usage per beam and/or c) beam switching, for the high priority users (e.g., the high priority users/devices in the environment, which may be the same as or different to the high priority users from which the data is obtained in 310).

For example, a network entity may use the AI/ML model to configure an alternative beam set to be used by a device in a specific time period or location, based on knowledge, gained through the AI/ML model and application of inference, that beam failure may occur if the device does not switch to the alternative beam set. In certain examples, differential coding is used for the beam sequence from the start point of the RRC connected mode for the device, to facilitate signalling to capture beam related information for use as AI/ML training data in the RRC connected mode for the device. In an example, differential coding is applied to the network side (e.g., to a gNB side), where many beams (e.g., 64 beams, 128 beams) can be employed by the massive MIMO systems. With this differential coding, the shift from the start beam position may be signalled as ±1, ±2 or ±3, for example. In another example, from a device side (such as the device referred to above), different device models will support a different number of beams (e.g., 4 beams, 8 beams, 16 beams). In this case, reporting this information to the AI/ML model (or entity training the AI/ML model) may be needed to avoid ambiguity.

In another example, a device may control a) or b) based on the AI/ML model(s). In certain examples, in the case of a) and/or b), differential coding may be used to indicate the ± change in the number of RACH codes from the default setting, to facilitate signalling for capturing the number of RACH codes per beam for a given RACH occurrence.

In certain examples, the trained AI/ML model may be transmitted or delivered to one or more other network entities. For example, the AI/ML model may be transmitted, delivered, broadcast, multicast, or unicast etc. to devices (such as UEs) in the environment. A device may then use the AI/ML model in performing or controlling beam sweeping according to a method described herein, and/or in allocating RACH resources according to a method as described herein. In another example, the AI/ML model may be transmitted to another network entity which is to perform communication with the device(s) in the environment, such as a network entity that configures an alternative beam set as described in relation to operation 320. In other words, the AI/ML model may be trained by a network entity which is itself not expected to use the AI/ML model, with the network entity then providing the trained AI/ML model to other network entity/entities that are to use the model.

Operations 310, 320, 330 are shown in FIG. 3; any of these operations may be omitted, the order of the operations may change, and/or any of these operations may be combined with other operations. For example, operation 320 may represent on-going model training of an existing model, and so operation 310 and/or operation 320 may be omitted with operation 330 being performed on the basis of said existing model instead—in other words, certain exemplary methods include the execution of a trained AI/ML model as described in operation 330, without necessarily including the obtaining of data and training of the model. In another example, operation 330 may be omitted such that the network entity obtains data and uses the data for AI/ML model training, without a method also including execution of the model(s). In yet another example, operations 320 and 330 maybe omitted such that the method simply includes the obtaining of suitable data for AI/ML model training. In other words, any combination of operations 310, 320 and 330 (including taking each operation alone) is envisaged.

Further examples in accordance with the present disclosure are set out in the following methods, where aspects of these methods may be combined with the approaches described above.

A method for using an AI/ML model for predicting and provisioning the most frequently used beams more regularly and promptly in initial access. The related SSB/CSI-RS measurements from beam sweeping in environments with non-uniform (in space and/or time) user distributions may be used to train AI/ML models and the inference from the models used to control/modify beam sweeping. The modified beam sweeping can provide high priority (low latency) access to the required users and also to reduce overheads in beam management.

A method wherein the SSB/CSI-RS measurements (data) are collected in a manner to reduce the overheads. Out of the possible M beam pairs (for transmission and reception), measurements are taken of a subset of N beam pairs, which are selected or most likely to be selected in beam sweeping. Thus the measurement (data) collection for AI/ML model training may be done in scenarios where non-uniform beam access by the UEs is likely to happen and the model later applied to such scenarios.

A method wherein the inference from the above-mentioned trained AI/ML model increases the priority and/or frequency of highly indicated beams in the beam sweeping for initial access. Therefore the beams requested more frequently by the UEs may appear earlier in the beam sweep and more frequently. The AI/ML models may be calibrated such that even if some beams are not indicated, they are not completely removed from the beam sweep over a longer time period.

A method wherein the inference from the above-mentioned trained AI/ML model assists with control of the RACH operation, prioritizing resource allocation to highly indicated beams in the beam sweeping for initial access. Therefore, the beams requested more frequently by the UEs may be allocated more RACH resources in specific temporal zones (time periods) or spatial zones (e.g. geographic region, a zone, an orientation etc.) The AI/ML models may be calibrated such that even if some beams are not indicated, they are not completely removed from the RACH operation over a longer time period.

A method according wherein the frequency of usage for each of the N beam pairs can be recorded and used to train an AI/ML model for RACH resource optimization. Out of the possible M beam pairs, relatively more RACH resources may be allocated to a subset of N beam pairs, which are selected or most likely to be selected in beam sweeping. Therefore, the resources are prioritized for non-uniform beam access by the UEs, providing reductions in the overheads.

A method for using an AI/ML model for predicting and provisioning the most frequently used beams more regularly and promptly in RRC connected mode. The related CSI-RS/DMRS measurements for beam selection in environments with non-uniform (in space and time) user distributions and trajectories may be used to train AI/ML models and the inference from the models used to control/modify beam switching. The measurement (data) collection for AI/ML model training may be done in scenarios where UEs operate across multiple beams (or multiple gNBs/eNBs) and the model later applied to such scenarios.

A method wherein the inference from the above-mentioned trained AI/ML model are used to modify the beam set configuration, prioritizing beam pairs according to the trajectory of a device. Thus the beams likely to fail due to external circumstances such as blockages are deselected in the relevant temporal zones (time periods) or spatial zones (e.g. geographic region, a zone, an orientation etc.). The modified beam set configuration may provide low latency access to the required users and also reduce overheads in beam management.

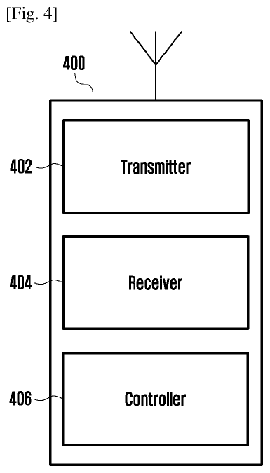

FIG. 4 is a block diagram illustrating an exemplary network entity 400 (or electronic device, or network node etc.) that may be used in examples of the present disclosure. For example, a UE, device or network as described in any of the embodiments/examples disclosed above may be implemented by or comprise network entity 400 (or be in combination with network entity 400).

The network entity 400 comprises a controller 405 (or at least one processor) and at least one of a transmitter 401, a receiver 403, or a transceiver (not shown).

To give some separate, non-limiting examples: the controller 405 may train an AI/ML model using data obtained/received/collected by the receiver 403; the controller 405 may control a beam management related operation on the basis of the AI/ML model, either for the network entity 400 or in relation to another entity in the network; the transmitter 401 may transmit an AI/ML model to another entity in the network; the receiver 403 may receive an AI/ML model from another entity in the network; the transmitter 401 may transmit training data to another entity in the network, for use in training an AI/ML model.

It will be appreciated that, in each example/embodiment/aspect etc. described above, one or more features or operations may be omitted, modified or moved (e.g., to change the order of the features or the operations), if desired and appropriate. Additionally, one or more features or operations from any example/embodiment may be combined with features or operations from any other example/embodiment.

The techniques described herein may be implemented using any suitably configured apparatus and/or system. Such an apparatus and/or system may be configured to perform a method according to any aspect, embodiment or example disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment and/or aspect disclosed herein, and/or a machine-readable storage storing such a program. Still further, such programs may be conveyed electronically via any medium, for example a communication signal carried over a wired or wireless connection.

While the invention has been shown and described with reference to certain examples, it will be understood by those skilled in the art that various changes in form and detail may be made therein without departing from the scope of the invention.

The reader's attention is directed to all papers and documents which are filed concurrently with or previous to this specification in connection with this application and which are open to public inspection with this specification, and the contents of all such papers and documents are incorporated herein by reference.

### Acronyms and Definitions

3GPP 3rd Generation Partnership Project
5G 5th Generation
5GC 5G Core
5QI 5G QoS Identifier
5GS 5G System
5GSM 5G System Session Management
5GMM 5G System Mobility Management
AF Application Function
AI Artificial Intelligence
AM Acknowledged Mode
AMF Access and Mobility Management Function
AS Application Server
ASP Application Service Provider
AUSF Authentication Server Function
DCAF Data Collection Application Function
DNAI Data Network Access Identifier
DNN Data Network Name
DNS Domain Name Server
DRB Data Radio Bearer
eNB Evolved Node B
FQDN Fully Qualified Domain Name
GBR Guaranteed Bit Rate
gNB Next generation Node B
GPSI Generic Public Subscription Identifier
IAB Integrated Access and Backhaul
ID Identity/Identifier
IIoT Industrial Internet of Things
IMEI International Mobile Equipment Identities
IP Internet Protocol
I-SMF Intermediate SMF
ML Machine Learning
MME Mobility Management Entity
MN Master Node
MNO Mobile Network Operator
MT Mobile Termination
NAS Non-Access Stratum
NEF Network Exposure Function
NRF Network Repository Function
NG-RAN Next Generation Radio Access Network
NG-eNB Next Generation eNB
NSA Non-Standalone
NSSF Network Slice Selection Function
NW Network
NWDAF Network Data Analytics Function
OS Operating System
OSAPP OS Application
PCF Policy Control Function
PCO Protocol Configuration Options
PDR Packet Detection Rule
PDU Protocol Data Unit
QFI QoS Flow Identifier (ID)
QoS Quality of Service
RACH Random Access Channel
RAN Radio Access Network
RSD Route Selection Descriptor
SA Standalone
SDAP Service Data Adaptation Protocol
SDU Service Data Unit
SIM Subscriber Identity Module
SLA Service Level Agreement
SM Session Management
SMF Session Management Function
SN Secondary Node
S-NSSAI Single Network Slice Selection Assistance Information
SSB Synchronization Signal Block
SSC Session and Service Continuity
SUPI Subscription Permanent Identifier
TAI Tracking Area Identity
TE Terminal Equipment
TM Transparent Mode
TS Technical Specification
UDM Unified Data Manager
UDR Unified Data Repository
UE User Equipment
UL Uplink
UM Unacknowledged Mode
UP User Plane
UPF User Plane Function
URLLC Ultra-Reliable and Low-Latency Communication
URSP UE Route Selection Policy

1. A method for artificial intelligence/machine learning (AI/ML)-based beam management performed by a network entity in a communications system, the method comprising:
identifying at least one inference from a beam management AI/ML model based on a subset of plurality beams;
identifying at least one beam among a plurality of beams based on an inference for a user equipment (UE) using information associated with the UE; and
transmitting a signal to the UE based on the at least one beam.

2. The method of claim 1, wherein identifying the at least one beam comprises at least one of:
identifying, based on the inference from the beam management AI/ML model, the at least one beam among the plurality of beams for beam sweeping for initial access;
identifying, based on the inference from the beam management AI/ML model, the at least one beam among the plurality of beams for allocating random access resources to the at least one beam for the initial access; and
identifying, based the inference from the beam management AI/ML model, the at least one beam among the plurality of beams for beam switching of the UE.

3. The method of claim 1, wherein the information associated with the UE includes information on an area, information on a time, information on a UE trajectory, or a UE identity.

4. The method of claim 1, wherein the subset of the plurality of beams includes at least one of a beam used by a high-priority UE, a beam used by a UE in a location associated with high-priority access, a beam used by a UE at a high-priority time, a beam with a relatively higher performance, or a beam that has failed.

5. A method for artificial intelligence/machine learning (AI/ML)-based beam management performed by a user equipment (UE) in a communications system, the method comprising:
identifying at least one inference from a beam management AI/ML model based on a subset of plurality beams;
identifying at least one beam among a plurality of beams based on an inference for the UE using information associated with the UE; and
receiving a signal from a network entity based on the at least one beam.

6. The method of claim 5, wherein identifying the at least one beam comprises at least one of:
identifying, based on the inference from the beam management AI/ML model, at least one beam among the plurality of beams for beam sweeping for initial access;
identifying, based on the inference from the beam management AI/ML model, at least one beam among the plurality of beams for allocating random access resources to the at least one beam for the initial access; and
identifying, based the inference from the beam management AI/ML model, at least one beam among the plurality of beams for beam switching of the UE.

7. The method of claim 5, wherein the information associated with the UE includes information on an area, information on a time, information on a UE trajectory, or a UE identity.

8. The method of claim 5, wherein the subset of the plurality of beams includes at least one of a beam used by a high-priority UE, a beam used by a UE in a location associated with high-priority access, a beam used by a UE at a high-priority time, a beam with a relatively higher performance, or a beam that has failed.

9. A network entity for artificial intelligence/machine learning (AI/ML)-based beam management in a communications system, the network entity comprising:
a transceiver; and
a controller coupled with the transceiver and configured to:
identify at least one inference from a beam management AI/ML model based on a subset of plurality beams,
identify at least one beam among a plurality of beams based on an inference for a user equipment (UE) using information associated with the UE, and
transmit a signal to the UE based on the at least one beam.

10. The network entity of claim 9, wherein the at least one beam among the plurality of beams is used for at least one of beam sweeping for initial access, allocation of random access resources to the at least one beam for the initial access, or beam switching of the UE.

11. The network entity of claim 9, wherein the information associated with the UE includes information on an area, information on a time, information on a UE trajectory, or a UE identity.

12. The network entity of claim 9, wherein the subset of the plurality of beams includes at least one of a beam used by a high-priority UE, a beam used by a UE in a location associated with high-priority access, a beam used by a UE at a high-priority time, a beam with a relatively higher performance, or a beam that has failed.

13. A user equipment (UE) for artificial intelligence/machine learning (AI/ML)-based beam management in a communications system, the UE comprising:
a transceiver; and
a controller coupled with the transceiver and configured to:
identify at least one inference from a beam management AI/ML model based on a subset of plurality beams,
identify at least one beam among a plurality of beams based on an inference for the UE using information associated with the UE, and receive a signal from a network entity based on the at least one beam.

14. The UE of claim 13, wherein the at least one beam among the plurality of beams is used for at least one of beam sweeping for initial access, allocation of random access resources to the at least one beam for the initial access, or beam switching of the UE.

15. The UE of claim 13, wherein the information associated with the UE includes information on an area, information on a time, information on a UE trajectory, or a UE identity, and
wherein the subset of the plurality of beams includes at least one of a beam used by a high-priority UE, a beam used by a UE in a location associated with high-priority access, a beam used by a UE at a high-priority time, a beam with a relatively higher performance, or a beam that has failed.
